(19) United States
(12) Patent Application Publication
(10) Pub. No.: US 2013/0241713 A1
(43) Pub. Date: Sep. 19, 2013

(54) Method and Read/Write Device for Interchanging Data Between a Wirelessly Accessible Data Memory and an Industrial Automation Component

(71) Applicant: Markus Weinländer, Happurg (DE)

(72) Inventor: Markus Weinländer, Happurg (DE)

(73) Assignee: SIEMENS AKTIENGESELLSCHAFT, Muechen (DE)

(21) Appl. No.: 13/547,780

(22) Filed: Jul. 12, 2012

(30) Foreign Application Priority Data
Jul. 15, 2011 (EP) EP11174216.9

(51) Int. Cl. G06K 19/07

(52) U.S. Cl. CPC G06K 19/0723
USPC 340/10.52

(57) ABSTRACT

A method and a read/write device for addressing at least one wirelessly accessible data memory in an arrangement having a read/write device for the at least one data memory and an industrial automation component, wherein the data memory is addressed, during radio-based data interchange between the data memory and the read/write device, using a first identification number of the data memory. The read/write device assigns a second identification number to the first identification number of the data memory, and the second identification number is used to identify the data memory in the event of data interchange between the read/write device and the automation component based on this data memory. As a result, the automation component can use shortened identification numbers, and there is still unique addressing between the automation component and the wirelessly accessible data memory.

### BACKGROUND OF THE INVENTION

1. Field of the Invention

The invention relates to a method for addressing at least one wirelessly accessible data memory and to a read/write device for interchanging data between a wireless data memory and an industrial automation component.

2. Description of the Related Art

RFID systems and RFD transponders have become established as mobile data memories, i.e., in industrial automation technology, which systems and transponders are not only used to identify all types of goods but are also used as decentralized data memories. Consequently, it is not only possible to read a unique identification number from an RFID transponder, i.e., the mobile data memory, but also to write useful data to the mobile data memory and to re-read the data from the mobile data memory. For this purpose, the transponders have data memories, i.e., a “user memory” which, in many cases, may have a size of up to 32 kB.

With the release of the ultra-high frequency (UHF) for RFID applications, the EPCglobal standard has become established. In order to identify goods in logistics and similar applications, the standard provides a unique number as an identification feature, i.e., an EPC ID, which is able to have different lengths of between 16 and 496 bits. In the extension of the standard, EPCglobal Class 1 Gen 2, these transponders are also able to use a “user memory”. If the intention is to read the associated “user memory” of a multiplicity of transponders available in the radio range of a read/write device, a control device, such as an industrial automation component, e.g., programmable logic controller (PLC), must transmit the EPC ID of the desired transponder to the read/write device, where this EPC ID is then also being used to address the desired transponder on an air interface.

However, when the read/write devices are combined with such industrial automation components, i.e., the programmable logic controllers, the problem arises in that the entire length of the identification numbers, i.e., the EPC IDs, of the mobile data memories (transponders) must be processed by the automation program. Depending on the configuration of the EPC ID, this means that a binary coded numerical value with a length of 16 to 496 bits must be processed. However, the standard data types conventionally used in the programmable logic controllers have a maximum “width” of generally 32 bits (DWORD data type). Identification numbers that are longer than 32 bits must be stored as an array or in a self-defined data type, which, on the one hand, means an increased requirement for storage space and, on the other hand, a loss of “performance” when executing an automation program. In addition, it is more complicated to handle such data structures during programming than storing identification numbers in variables of a standard data type, for example.

As a remedy to the problem, it is a known practice to use only part of the actual EPC ID for addressing, for example, the last (least significant) 64 bits. This “truncated” EPC ID, which is then thus used in communication between the read/write device and the automation component, is then in turn supplemented with the previously truncated part again by the read/write device for communication, over the air interface, with the RFID transponders, i.e., the data memories. Consequently, on the one hand, the address space that can be actually used is considerably restricted and, on the other hand, the “truncated part” of the EPC IDs must be the same for all transponders used, which can be guaranteed only in logically closed applications. In “open” applications, i.e., those applications in which goods with such data memories (transponders) from other companies etc. are intended to be exchanged, unique addressing regularly cannot be guaranteed when the address space is restricted to the least significant 64 bits, for example.

### SUMMARY OF THE INVENTION

It is therefore an object of the present invention to simplify the use of the identification numbers of mobile data memories in applications with industrial automation components.

This and other objects and advantages are achieved in accordance with the invention by introducing a shortened identification number, i.e., a virtual EPC ID, for the purpose of identifying a mobile wireless data memory, where this shortened identification number is automatically allocated by a read/write device. For this purpose, the read/write device is intended to have an area, such as a table, in which a second virtual identification number is dynamically assigned to each actual read EPC ID of the detected data memories. This shortened identification number may consist of a 32-bit value (DWORD data type), for example. This second identification number can thus be processed in a considerably faster and simpler manner in an application program (PLC program) of an industrial automation component but nevertheless provides a sufficiently large number space to distinguish a sufficiently large number of data memories (RFID transponders).

In accordance with the invention, a method is provided for addressing at least one wirelessly accessible data memory in an arrangement having a read/write device for the at least one data memory and an industrial automation component, where the data memory is addressed, during radio-based data interchange between the data memory and the read/write device, using a first identification number of the data memory. The read/write device then assigns a second identification number to the first identification number of the data memory, which second identification number is respectively used to identify the data memory in the event of data interchange between the read/write device and the automation component based on this data memory. As a result, on the one hand, it is possible to save transmission bandwidth on the interface between the read/write device and the automation component and, on the other hand, the second identification numbers can be processed in a considerably improved manner by the automation component than the “unshortened” first identification numbers.

It is also an object to provide a read/write device for interchanging data between a mobile wireless data memory and an industrial automation component, where the read/write device is set up to address the data memory, during radio-based data interchange, using a first identification number, this first identification number being permanently assigned to the data memory. Here, the read/write device is set up to generate and assign a second identification number to the first identification number at least when the data memory is first detected, and the read/write device is set up to use the second identification number for data interchange with the automation component, which data interchange concerns the data memory. Such a read/write device makes it possible to achieve the advantages described with respect to the method in accordance with the invention.

The advantages with regard to the processing of the second identification number by the industrial automation component come into effect, in particular, when the second identification number has a smaller number of bits than the “original” first identification number. However, it is also possible for the second identification number to indeed have an unchanged or even larger “number of bits” but to be differently coded. This may be useful, for example, in situations in which the actual identification number of the mobile data memory is intended to be withheld from an automation program or additional information is intended to be encrypted within the second identification number, for example, the reception field strength with respect to the radio-based data interchange with the respective data memory or transponder.

The assignment between the first identification number and the second identification number is advantageously stored in the read/write device using a database or table. This is important, in particular, when applications are not only intended to be informed of the presence of a data memory, but when the application is also intended to transmit read requests or write requests with respect to a previously detected data memory to the read/write device. The assignments stored in the table are then needed to be able to subsequently re-address the previously read or detected data memory.

In particular, in the case of a plurality of wireless data memories, the read/write device is intended to respectively allocate the second identification numbers when the respective data memory is detected for the first time. This means that a further identification number is not allocated if the same data memory is repeatedly detected. As a result, there is only a unique assignment between the first identification number and second identification number for each data memory detected. The assignment is intended to be re-deleted or re-canceled only when the relevant data memory could no longer be detected for a time. This means that a maximum period of time is predefined and the period of time elapsed since the last detection is measured for each detected data memory, where the corresponding entry in the table or database is deleted after the maximum period of time. If a data memory is re-detected before the period of time expires, the period of time is reset, which means that the period of time begins to run anew.

The second identification numbers are advantageously assigned to the data memories with ascending numbering in the order in which they are detected (for the first time). If the identification number is incremented by “1” with each newly detected data memory, the available address space is used in the best possible way for the second identification numbers. In one advantageous embodiment, the allocation of the second identification numbers is not always started at “0” or “1”, but rather with a starting value that is advantageously obtained based on a pseudo random number. This may be advantageous, for example, in situations in which a read/write device briefly fails or is “reset”. In such a case, the data memories available in the reception range of the read/write device would be re-inventoried, but the second identification numbers re-allocated would not, with a high degree of probability, denote the same data memories as was the case before the read/write device was “reset”. In the event of subsequent requests from the automation component, the wrong data memories would then be addressed. In contrast, when a pseudo random number is used as the “starting value”, those second identification numbers that have not yet been used at all during previous operation are generated, with a high degree of probability, when the read/write device is restarted or “reset”. Incorrect addressing operations can thus be avoided.

Applications are known in which important information (“useful data”) is encrypted in the first identification number of the data memories. If the automation component requires these useful data, the automation component can transmit a request to the read/write device, stating the second identification number. The request comprises, on the one hand, the second identification number of the data memory in question and, on the other hand, advantageously specifies those areas (bit sequence or the like) which are of interest. The read/write device then returns the corresponding section of the first identification number to the automation component, together with the statement of the second identification number of the relevant data memory.

In another advantageous embodiment, information relating to the corresponding bit sequence may already be present in the read/write device. As a result, the bit sequence no longer needs to be specified in the request message by the automation component. This may mean, for example, that the first 32 or 64 bits of the first identification number, or another predefined bit sequence, is/are transmitted, in principle, using a request message.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Advantageous refinements of the method according to the invention are explained below using the drawings. They are simultaneously used to explain exemplary embodiments of read/write devices according to the invention, in which:

FIG. 1 schematically shows an arrangement of four data memories, a read/write device and an automation component in accordance with the invention; and

FIG. 2 shows the sequence of detecting, assigning and rejecting assignments using an exemplary “state machine” in accordance with the invention.

### DETAILED DESCRIPTION OF THE PREFERRED EMBODIMENTS

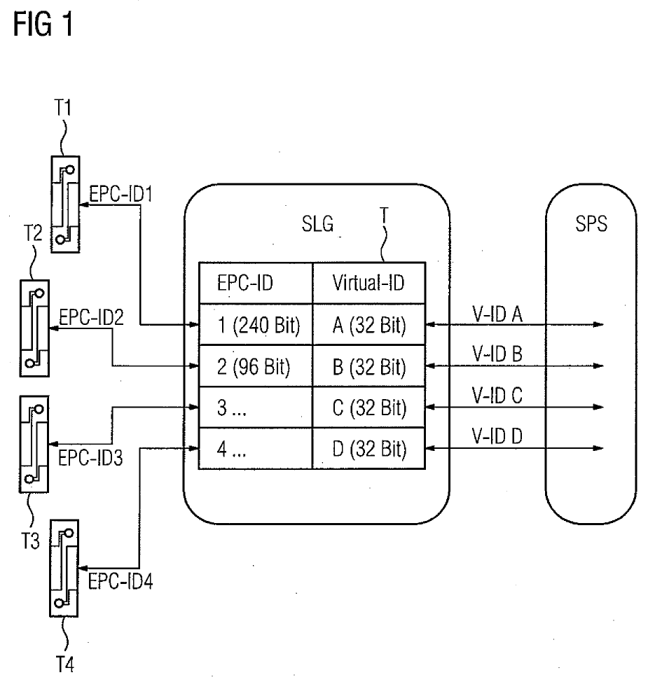

FIG. 1 schematically illustrates the mode of operation of the method in accordance with the invention. RFID transponders which are addressed according to the EPCglobal standard and are located in the radio range of a read/write device SLG are illustrated as data memories T1, T2, T3, T4. The read/write device is connected to an automation component SPS over a data link (not illustrated), such as a Profinet. The data memories T1, T2, T3, T4 are addressed using the first identification numbers EPC-ID1, EPC2-ID, EPC-ID3, EPC-ID4, where the identification number EPC-ID1 has a “length” of 240 bits and the identification number EPC-ID2 has a length of 96 bits. In the read/write device SLG, storage space for the table T which lists the identification numbers EPC-ID1, EPC-ID2, EPC-ID3, EPC-ID4 in a first column EPC-ID in the order in which they are detected for the first time is reserved in the volatile data memory (e.g., random access memory (RAM)).

Each time a data memory T1, T2, T3, T4 is detected for the first time, the read/write device SLG (“RFID reader”) now assigns a “virtual” second identification number V-ID A, V-ID B, V-ID C, V-ID D in the column “virtual ID” of the table T. These second identification numbers uniformly each consist of 32 bits, i.e., they are of the DWORD data type. In order to allocate the second identification numbers, the read/write device has a counter that is advantageously prefilled with a random number, i.e., a random starting value, when the read/write device SLG is started up or reset. This starting value is simultaneously the second identification number (virtual ID) for the first transponder that is detected by the read/write device SLG. For the next data memory (RFID transponder) detected, the starting value is incremented, like a counter, advantageously by the value 1. This incremented value is used as the second identification number for the second data memory detected, i.e., the data memory T2 in this case, etc.

If the read/write device (SLG) is set such that all newly detected data memories are reported to the automation component SPS, the read/write device SLG no longer transmits the first identification number, i.e., the EPC ID, after the respective detection, but rather only the second identification number. Conversely, if the automation component SPS wishes to have (write or read) access to the data memory, the automation component does not transmit the “globally valid” first identification number (not known to it) to the read/write device SLG, but rather the second identification number, i.e., the “virtual ID”, known to the automation component SPS. This second identification number is then translated, by the read/write device for communication over the air interface, to the first identification number (EPC ID) used by the data memories, and vice versa.

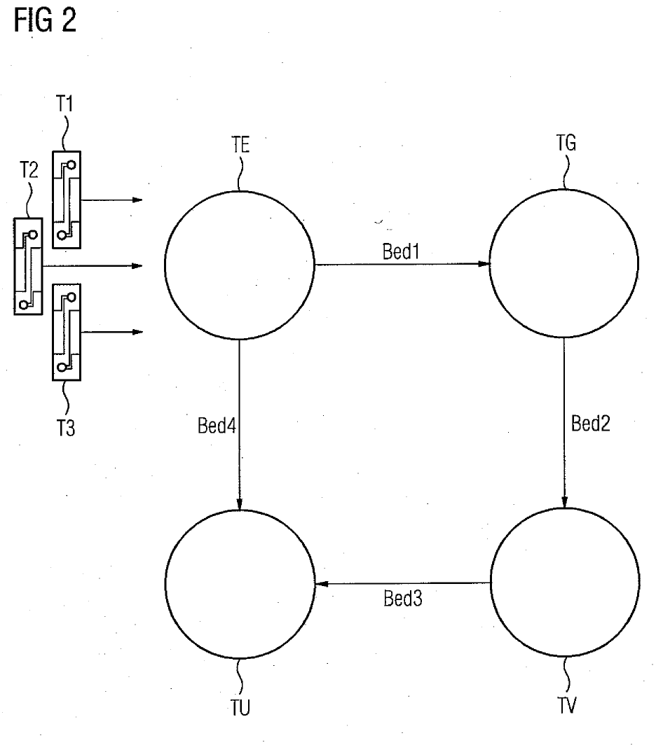

The validity period of the assignment of second identification numbers to the first identification numbers is explained below using FIG. 2. The data memories T1, T2, T3 are schematically illustrated in this case. The states TE, TG, TV, TU assigned to the data memories T1, T2, T3 are managed by the read/write device SLG in the manner of a “state machine”. This means that the possible sequence of states is defined and a change is made from one state to another as a result of events. These events are Con1, . . . Con4 (“condition 1, . . . , condition 4”) (not shown in FIG. 2).

When a data memory T1, T2, T3 is detected for the first time, a new row is created for the data memory in the table T, which presupposes that the first identification number (EPC ID) of the respective data memory T1, T2, T3 has not yet been listed in the table T. The status TE (TAG detected) is assigned to the newly detected data memory T1, T2, T3; this status is also referred to as “glimpsed”. As the event Con1 for the next state change, it is assumed that the data memory T1, T2, T3 is detected in the radio range of the read/write device SLG for a minimum period of time. In an advantageous embodiment, this minimum period of time can be planned in the automation program of the automation component SPS and can be transmitted to the read/write device SLG using the automation component SPS over an interface and can be configured in such a way. After the occurrence of the condition Con1, a newly generated second identification number is assigned in the corresponding table entry. The state TG (TAG valid) is thus reached. This state is also referred to as “observed”. If the data memory T1, T2, T3 is not or has not been continuously detected for a maximum period of time which, in an advantageous embodiment, can likewise be planned and set using the automation component SPS, the condition Con2 is met. As a result, the corresponding second identification number is denoted invalid. The state TV (TAG lost), which is also referred to as “lost”, has thus occurred. Here, the first identification number of the corresponding data memory T1, T2, T3 has not yet been definitively deleted, which means that the state TG can be reset after “finding again”. However, if the data memory T1, T2, T3 cannot be read or found for a further period of time (condition Con3), the second identification number is deleted. As a result, the state TU (TAG unknown), which is also referred to as “unknown”, has been reached. As an alternative to deleting the second identification number of this data memory T1, T2, T3, the table entry can also be correspondingly labeled in a different manner. If the minimum detection duration is not reached (condition Con4) starting from the first detection (state TE), a change is directly made from the state TE to the state TU.

The second identification number, i.e., the “virtual ID”, is thus valid as long as the associated data memory T1, T2, T3 or “transponder” is located in the radio field of the read/write device (reader). Since radio holes may arise on account of the properties of the underlying UHF radio system, in particular as a result of reflections and obliterations, it may happen that a data memory is not detected during each “scan” of the read/write device SLG. In such a case, the described “state machine” in the read/write device SLG is used to avoid a new second identification number being assigned to the corresponding data memory T1, T2, T3. This “state machine” defines a particular period of time or a particular number of “scans” for which it is tolerated that a data memory is not located in the radio field or cannot be found there. Only then is the data memory deemed to be lost or unknown. That is, a new (different) second identification number is assigned during subsequent further detection of the data memory T1, T2, T3.

As a result of the fact that no complete global “EPC IDs” are used for addressing purposes, a performance advantage results with respect to the communication with the automation component and the data processing in the automation component. Two data memories T3, T4 each having a first identification number with a data field length of 240 bits each are intended to be considered as an example. If the automation component SPS is intended to read 16 bits in each case from the “user memory” of the data memories T3, T4 (not illustrated), for example, for the purpose of controlling a machine, 2×240 bits are transmitted (based on an implementation according to the prior art) as the EPC ID from the read/write device SLG to the automation component SPS solely for the purpose of addressing. Another 2×240 bits are then also transmitted from the automation component SPS to the read/write device SLG for the purpose of addressing the data memories T3, T4 and 2×16 bits are then transmitted, according to the read command, from the user memories, coupled with 2×240 bits of the EPC IDs (in order to be able to assign the corresponding entries from the “user memory” to the respective data memory T3, T4). As a result, a total of 1472 bits plus the “overhead” according to the protocol must be transmitted. As a result of the implementation in accordance with the disclosed embodiments of the invention, the second identification numbers (“virtual IDs”) each with 32 bits are always used instead of the EPC IDs having a length of 240 bits, with the result that the volume of data to be transmitted is only 224 bits (plus the overhead according to the protocol required in each case).

The “handles”, i.e., the address objects for the data memories T1, T2, T3, T4, can also be processed in a simpler manner in the automation component SPS.

Unwanted new formation of second identification numbers as a result of “radio holes” and similar interference is also avoided by using the described “state machine”.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for addressing at least one wirelessly accessible data memory in an arrangement having a read/write device for the at least one wirelessly accessible data memory and an industrial automation component, the method comprising:
addressing the data memory using a first identification number of the at least one wirelessly accessible data memory during radio-based data interchange between the at least one wirelessly accessible data memory and the read/write device;
assigning, by the read/write device, a second identification number to the first identification number of the at least one wirelessly accessible data memory; and
identifying the at least one wirelessly accessible data memory using the second identification number in an event of the radio-based data interchange between the read/write device and the automation component based on the at least one wirelessly accessible data memory.

2. The method as claimed in claim 1, wherein the second identification number comprises a binary coded numerical value having a smaller number of bits than a binary coded numerical value of the first identification number.

3. The method as claimed in claim 1, further comprising:
storing the assignment between the first identification number and the second identification number is stored in one of a database and or table in the read/write device.

4. The method as claimed in claim 1, further comprising:
allocating, by the read/write device, the second identification numbers for each of a plurality of wirelessly accessible data memories upon initially detecting the plurality of data memories.

5. The method as claimed in claim 4, wherein the second identification numbers are allocated in an ascending order, a pseudo random value being used as a starting value, and the pseudo random value being newly generated at least each time the read/write device is restarted.

6. The method as claimed in claim 1, wherein a validity of the second identification number and its assignment to the first identification number are limited to a predetermined period of time, the assignment of the second identification number to the first identification number one of becoming invalid and being deleted after the predetermined period of time.

7. The method as claimed in claim 6, wherein the read/write device resets the period of time each time a data memory of the plurality of wirelessly accessible data memories is re-detected.

8. The method as claimed in claim 1, further comprising:
transmitting, by the read/write device, a requested part of the first identification number of a data memory identified in the request to the automation component using the second identification number after a request from the automation component.

9. A read/write device for interchanging data between a wirelessly accessible data memory and an industrial automation component,
wherein the read/write device is configured to address the wirelessly accessible data memory, during radio-based data interchange, using a first identification number permanently assigned to the wirelessly accessible data memory;
wherein the read/write device is configured to generate and assign a second identification number to the first identification number at least when the wirelessly accessible data memory is first detected; and
wherein the read/write device is configured to utilize the second identification number for data interchange with the automation component, the data interchange being relevant to the wirelessly accessible data memory.

10. The read/write device as claimed in claim 9, wherein the second identification number has a smaller number of bits than the first identification number.

11. The read/write device as claimed claim 9, wherein the read/write device includes a storage device for storing assignments between first and second identification numbers of a plurality of data memories.

12. The read/write device as claimed in claim 10, wherein the read/write device includes a storage device for storing assignments between first and second identification numbers of a plurality of wirelessly accessible data memories.

13. The read/write device as claimed in claim 9, wherein, when a plurality of wirelessly accessible data memories are used, the read/write device is configured to allocate the second identification numbers in an ascending order each time a respective data memory of the plurality of wirelessly accessible data memories is initially detected.

14. The read/write device as claimed in claim 13, wherein the read/write device is configured to utilize a pseudo random value as a starting value for the ascending order, the read/write device being further configured to newly generate a pseudo random value at least each time the read/write device is restarted.

15. The read/write device as claimed in claim 13, wherein the read/write device is configured to determine a period of time which has elapsed since a last detection of each detected wirelessly accessible data memory of the plurality of wirelessly accessible data memories provided with an assignment, the read/write device being further configured such that the assignment is assessed to be invalid after a predetermined maximum period of time.

16. The read/write device as claimed in patent claim 14, wherein the read/write device is configured such that the predetermined maximum period of time is reset each time the data memory of the plurality of wirelessly accessible data memories is re-detected.

17. The read/write device as claimed in claim 9, wherein the read/write device is configured such that, after a request comprising a second identification number from the automation component, part of the first identification number of the data memory specified with the second identification number in the request is transmitted to the automation component.
